(19) United States
(12) Patent Application Publication
(10) Pub. No.: US 2006/0186656 A1
(43) Pub. Date: Aug. 24, 2006

(54) AIRBAG CUSHION

(75) Inventor: Masayoshi KUMAGAI, Shiga (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/276,260

(22) Filed: Feb. 21, 2006

Related U.S. Application Data
(60) Provisional application No. 60/655,014, filed on Feb. 22, 2005.

(51) Int. Cl. B60R 21/23

(52) U.S. Cl. 280/743.2; 280/729; 280/735; 280/743.1

(57) ABSTRACT

A device that includes an airbag and a tether that can be used to form the size and shape of the airbag. The device can include a winder connected to the tether for controlling the length of the tether. The device may be configured to control the size and shape of the airbag to more than two sizes when the airbag is in a deployed state. The airbag can include multiple chambers, wherein the size and shape of the chambers can be controlled independently.

### CROSS REFERENCE TO RELATED APPLICATION

This application claims priority to and the benefit of U.S. Provisional Patent Application Ser. No. 60/655,014, filed on Feb. 22, 2005, which is hereby incorporated by reference in its entirety.

### BACKGROUND

The present invention relates to an airbag device in which an airbag is inflated to protect a vehicle occupant in the event of a vehicle collision. More particularly, an airbag device with an improved airbag configuration for protecting an occupant more efficiently.

An airbag for protecting a vehicle occupant is normally stored in a folded state in a cavity disposed in the middle section of a steering wheel or within an instrument panel of a vehicle. In the event of a vehicle collision, the airbag is deployed and inflated in the vehicle interior by gas produced by an inflator. The inflated airbag receives and restrains the occupant.

In conventional airbag devices, the airbag when deployed does not leave a sufficiently safe distance between the airbag contact surface and the vehicle occupant, Thus, in a vehicle emergency the kinetic energy of the occupant is not efficiently absorbed by the airbag, which may result in injury to the occupant. In addition, when the occupant has a small build, the seat is often pulled forward to the front-most position. Such an occupant is plunged into a conventional airbag before the seatbelt has sufficient time to absorb impact energy. As a result, some passengers, especially children, have been fatally injured.

Another disadvantage of conventional airbags is that the restraint force of the airbag is not focused on the mass point of the occupant's head. Thus, the kinetic energy of the occupant's head is not efficiently absorbed.

Because the energy absorption effect of conventional airbags is not optimized, such airbags require increased volume and an inflator with increased output.

### SUMMARY

According to an embodiment, an airbag device includes an airbag; wherein the airbag includes an inside airbag member, an outside airbag member, a recess formed between the inside airbag member and the outside airbag member, and a tether; wherein the tether is connected to at least one of the inside airbag member and the outside airbag member; and a winding devices wherein the winding device is connected to the tether, wherein the winding device is arranged to control the size and shape of the airbag when the airbag is in a deployed state.

It is to be understood that both the foregoing general description and the following detailed description are exemplary and explanatory.

### BRIEF DESCRIPTION OF THE DRAWINGS

These and other features, aspects, and advantages of the present invention will become apparent from the following description, appended claims, and the accompanying exemplary embodiments shown in the drawings, which are described briefly below.

FIG. 1(a) is a schematic top view of a front-passenger airbag device in the fully deployed state according to an embodiment.

FIG. 1(b) is a schematic side view of the airbag device of FIG. 1(a).

FIG. 2(a) is a schematic top view of a front-passenger airbag device according to an embodiment showing a state in which the occupant is moving forward.

FIG. 2(b) is a schematic top view of the airbag device of FIG. 2(a) showing the moment when the occupant's face comes in contact with the airbag.

FIG. 2(c) is a schematic top plan view the airbag device of FIG. 2(a) showing a state in which the occupant is being restrained by the airbag.

FIG. 3(a) is a rear view showing an airbag device according to an embodiment.

FIG. 3(b) is a schematic side view of a left half of the airbag device of FIG. 3(a).

FIG. 4 is a perspective view of an airbag device according to an embodiment,

FIG. 5 is a perspective view of an airbag device according to an embodiment.

FIG. 6 is a perspective view of an airbag device according to an embodiment.

FIG. 7 is a perspective view of an airbag device according to an embodiment.

FIG. 8 is a schematic top view of an airbag device according to an embodiment.

FIG. 9(a) is a perspective view of an airbag device according to an embodiment.

FIG. 9(b) is a top sectional view of the airbag device of FIG. 9(a).

FIG. 10 is a schematic top view of an airbag device according to an embodiment.

FIG. 11 shows a view of an embodiment of an airbag with left and right projections.

FIG. 12(a) is a top view of an embodiment of the present invention for controlling the shape of an airbag.

FIG. 12(b) is a top view of a deployed airbag with a controlled shape according to an embodiment.

FIG. 13 is a side view of the airbag device shown in FIG. 12(b).

FIG. 14(a) is a top view of an embodiment of the present invention for controlling the shape of an airbag.

FIG. 14(b) is a top view of a deployed airbag with a controlled shape according to an embodiment.

FIG. 14(c) is a top view of a vehicle crash example.

FIG. 15 is a side view of an airbag device according to an embodiment of the present invention.

FIG. 16 is a top view of an airbag device according to an embodiment.

FIG. 17 is a top view of an airbag device according to an embodiment.

### DESCRIPTION

Embodiments will be described with reference to the attached drawings.

In the description below, the longitudinal direction is identical to that of a vehicle in which the head-protecting airbag is mounted. Although the following embodiments are directed to an airbag device for a passenger seat mounted in the upper part of a vehicle dashboard, the airbag device can be applied to an airbag other than for a passenger seat.

According to an embodiment, an airbag device is provided. The airbag device includes an airbag that is normally stored in an upper part of an instrument panel. The airbag can be inflated and deployed into a space in front of a vehicle occupant in the event of an emergency, such as a vehicle collision. In a top view, the airbag upon completion of deployment has a right side portion, a left side portion, and a recess formed between the right and left side portions. The recess can maintain a recessed shape when pressure is applied to the right and left side portions.

According to another embodiment, an airbag device is provided. The airbag device includes an airbag that is normally stored in an upper part of an instrument panel. The airbag can be inflated and deployed into a space in front of a vehicle occupant in the event of an emergency, such as a vehicle collision. When the airbag makes contact with the occupant's head during an emergency, the contact surface extends from the deepest section of the recess to the right side end of the recess (right contact surface) and from the deepest section of the recess to the left side end of the recess (left contact surface). The left and right contact surfaces can be disposed at an angle of about 15 to 90 degrees (preferably 30 to 60 degrees) relative to the line extending through the deepest section of the recess in the longitudinal direction of the vehicle (the airbag centerline).

Thus, by projecting the front surface of the airbag toward an occupant, the area of the occupant's head corresponding to the mass point (center of gravity) of the occupant's head can come in contact with the front surface of the airbag, which enables more efficient restraint of the occupant's head during the initial stage of impact. If the angle between the contact surface and the airbag centerline exceeds about 90 degrees, the efficiency is lost, If the angle is less than about 15 degrees, the recess doesn't cover the occupant's head.

According to another embodiment, an airbag device is provided. The airbag device includes an airbag that is normally stored in an upper part of an instrument panel. The airbag can be inflated and deployed into a space in front of a vehicle occupant in the event of an emergency, such as a vehicle collision. In a top view, the airbag upon completion of deployment has a right side portion, a left side portion, and a recess formed between the right and left side portions. The front surface of the airbag projects toward an occupant. The front surface is formed to project so that the area corresponding to the mass point (center of gravity) of the heads of occupants of different sizes/builds comes in contact with the area of the front surface of the airbag extending from the deepest section of the recess to the right and left side ends of the recess.

Thus, because the front surface of the airbag projects toward an occupant, the mass point of the occupant's head can be restrained in an earlier stage of the impact. And since the energy absorption effect of the airbag is raised, the occupant's head can be restrained more efficiently during the earlier stage of the impact.

In a vehicle emergency, the shoulder portions of the occupant first press the airbag and are the first part of the occupant to receive a reaction force of the airbag. In particular, the shoulders of an occupant can make contact with the right and left side portions of the airbag before the head of the occupant contacts a recess in the airbag. Due to such contact between the shoulders of an occupant and the right and left side portions of the airbag, the pressure in the right and left side portions increases and is supplied to the recess so as to increase the inner pressure of the recess. Thus, the energy absorption effect of the right and left side portions and of the recess is increased.

When the shoulders of the occupant press the airbag, the inner pressure of the airbag increases. Even when the inner pressure increases, the airbag is constructed such that the recessed shape of the airbag is maintained. Because the recessed configuration of the airbag is maintained, it is difficult for gas pressure to leak out, which enhances the efficiency of the restraint of the occupant's shoulders at the initial stage of restraint. Thus, in such an airbag, the airbag is first compressed by the occupant's shoulders, which causes the inner pressure (reaction force) of the airbag to rise. The increased inner pressure enhances the initial restraint of the occupant's shoulders. Next, because the airbag has a recess and the area where the recess is formed does not deform much, gas is supplied into the airbag without a substantial deformation of the recess and without lowering the inner pressure. As a result, the inner pressure of the airbag, including the recess, is raised higher than that of a conventional airbag. Occupant restraint capability is thus improved. Because the energy absorption effect of the recess is improved, the moving distance of the occupant (stroke of the occupant) before the occupant stops is reduced. Therefore, the need for increasing the output of the inflator is eliminated and initial restraint of the occupant is safely achieved. The increased energy absorption effect also allows a reduction in the volume of the airbag so that a compactly constructed airbag may be used.

According to an embodiment, an angled surface of the airbag's recess, which extends from the deepest section of the recess to a right side end of the airbag (the right contact portion) and from the deepest section of the recess to a left side end of the airbag (the left contact portion), is adapted so that the area of the occupant's face opposite the center of gravity (mass point) of the occupant's head (i.e., the area between the eyebrows of the occupant) will always come into contact with the contact surface of the airbag. The angled surface extends such that the contact surfaces extending from the deepest section of the recess to the right and left side ends of the contact surface (the right and left contact portions) form an angle of about 15 to 90 degrees (preferably 30 to 60 degrees) relative to the line extending through the deepest section of the recess in the longitudinal direction of the vehicle (the airbag centerline). In such an airbag, the restraint force of the recess is focused on the area of the occupant's head corresponding to the mass point thereby absorbing the kinetic energy of the occupant's head in a most efficient manner. In addition, when the occupant has a small build, the seat is often pulled forward to the front-most position. When such an occupant is plunged into the airbag during a vehicle collision, the recess allows frontward movement of the occupant. Thus, the recess provides an extra distance (stroke) for the occupant's head to move frontward and allows the occupant to be sufficiently decelerated by a seat belt before the occupant's head makes contact with the airbag.

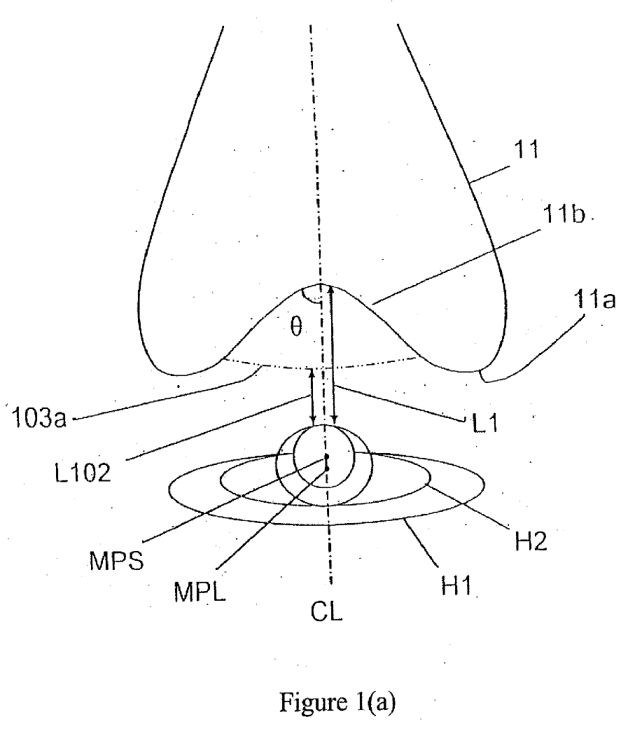

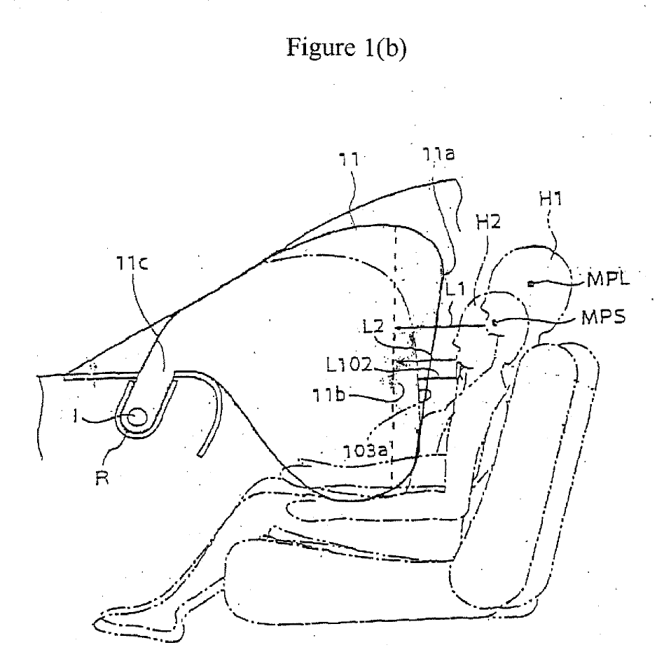

FIG. 1(a) is a schematic top view showing a front-passenger airbag device in the fully deployed state according to an embodiment of the present invention. FIG. 1(b) is a schematic side view of the airbag device in FIG. 1(a). The airbag device has a retainer R disposed facing the windshield above the instrument panel of a vehicle. Arranged in the retainer R are an airbag 11 preferably made of fabric and an inflator I for supplying gas into the airbag for deployment of the airbag. The airbag 11 can be stored inside the retainer R in a folded state. The volume of the airbag 11 can be in a range of approximately 110 to 132 liters when the airbag 11 is of a small size. The base of the airbag 11 can include a narrow end opening (gas inlet) 11c, which is connected to the inflator I. The end opening 11c allows the flow of gas from the inflator I into the airbag 11. The front face of the airbag 11 has a contact surface 11a, which comes in contact with the occupant when the airbag deploys.

A recess 11b is provided in the vicinity of the center area of the contact surface 11a of the airbag 11. The recess 11b may be in the form of, for example, a constriction, a hollow, or a valley in the airbag. The recess 11b preferably extends from the top of the airbag 11 to the bottom of the airbag 11 so that the recess 11b is visible in a top view of the airbag. In the preferred embodiment, the fully deployed airbag 11 has a configuration in its top view showing a right side portion, a left side portion, and a recess formed between the left side portion and the right side portion.

FIGS. 1(a) and 1(b) show two occupants H1, H2 of different builds. The occupant H1 has a larger build than the occupant 112. The distance between the jaw area of the occupant H1 and the recess 11b (center of the contact surface 11a) of the deployed airbag is indicated by L1. The distance between the jaw area of the occupant H2 and the recess 11b (center of the contact surface 11a) of the deployed airbag is indicated by L2. For example, L1, L2 may be on the order of 100 mm or the like. For comparison, a contact surface 103a of a conventional airbag is also shown. As can be seen, the distance L102 between the contact surface 103a of a conventional airbag and the jaw area of the occupant H2 is less than the distance L2 between the jaw area of the occupant H2 and the center of the contact surface 11a.

Thus, in the airbag device shown in FIGS. 1(a) and 1(b), the existence of the recess 11b makes the distance L2 between the occupant H2 and the contact surface 11a not so different from the distance L1 between the occupant H1 and the contact surface 11a. This enables the occupant H2 also to be sufficiently decelerated by the seat belt before the head portion of the occupant H2 comes into contact with the airbag 11.

In FIGS. 1(a) and 1(b), the mass points position of center of gravity) of the heads of the occupants H1, H2 are represented by MPL and MPS, respectively. In the airbag device according to this embodiment, a front surface of the airbag is formed so that the portions of the heads of the occupants H1, H2 corresponding to the mass points MPL, MPS will come into contact with the front surface area of the airbag extending (or projecting) from the deepest section of the recess 11b to the right side end (the right contact portion) and from the deepest section of the recess 11b to the left side end (the left contact portion) toward the occupants H1, H2. Thus by projecting the front surface of the airbag in a direction toward the occupant, the occupant can be restrained more safely during the initial stage of the impact than is possible with a conventional airbag.

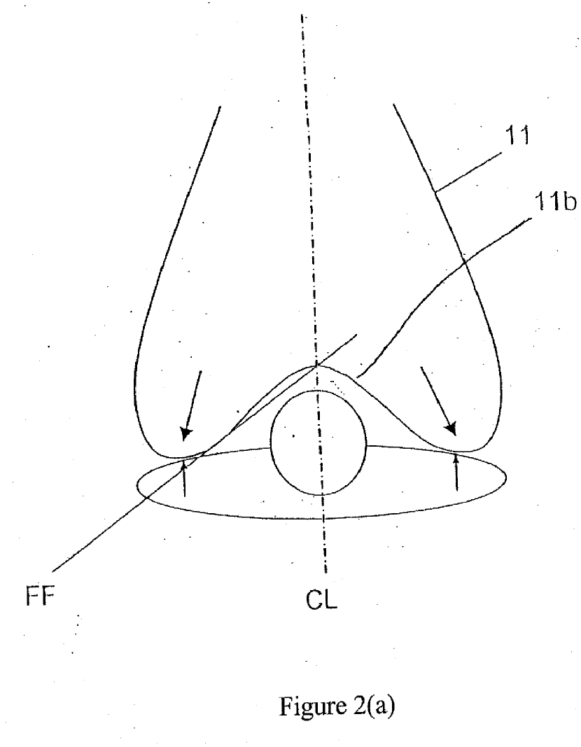

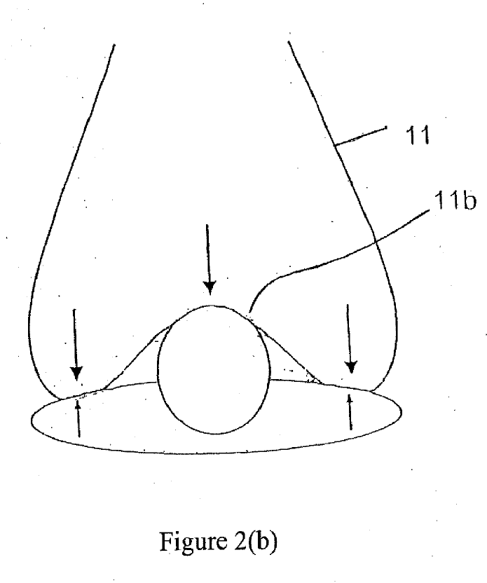

With reference to FIG. 2, additional configurations and functions of an airbag device according to an embodiment will now be described. FIG. 2(a) is a schematic top view showing a state where the occupant is moving forward. FIG. 2(b) is a schematic top view showing a state where the occupant's face just comes into contact with the airbag, Finally, FIG. 2(c) is a schematic top view showing a state where the occupant is being restrained by the airbag.

As shown in FIG. 2(a), when an occupant has moved forward, the shoulder portions of the occupant first come into contact with the airbag 11. Inside the airbag 11, bold arrows indicate reactive force (pressure), In this embodiment, a recess 11b restricts the flow of pressure, thereby preventing pressure from escaping from the right and left portions (shoulder/side projections) of the airbag 11 to ensure that the occupant is fully restrained during the initial stage of the impact. Thus, it is necessary to form the airbag so that the recess maintains its recessed shape even when the pressure is applied to the right and left portions of the airbag.

FIG. 2(b) shows a moment when the occupant's face just comes into contact with the airbag. In FIG. 2(b), a line FF extends toward and an occupant from the deepest section of the recess 11b to left side end of the recess 11b (FFL) and from the deepest section of the recess 11b to the right side end of the recess 11b (FFR). The line FF (FFL, FER) forms an angle of about 15 to 90 degrees (preferably 30 to 60 degrees) relative to the line CL extending through the deepest section of the recess in the longitudinal direction of the vehicle. In other words, the angle θ is formed at the intersection of the line FF (or the contact surface 11a) and the line CL. In this way, the area of the occupant's head corresponding to the center of gravity MP of the occupant's head (the area between the eyebrows) can be restrained with certainty, and the kinetic energy of the head can be absorbed in a most efficient way.

FIG. 2(c) shows a state where the occupant is fully restrained by the airbag 11. As the occupant further moves forward from the state in FIG. 2(b), the shoulder portions of the occupant push against the right and left side portions of the airbag, thereby compressing the right and left sides of the airbag. Since the shape of the recess 11b is maintained even when the inner pressure of the airbag rises, much of the gas pressure is kept from escaping. Consequently, the reaction force of the right and left sides of the airbag increases, enhancing the initial occupant restraint capability. Thus, gas pressure is effectively supplied to all portions of the airbag, including the recess 11b. As a result, the energy absorption effect of the recess is improved. The stroke of the occupant's head is reduced, the need for boosting the inflator output is eliminated, and the volume of the airbag can be made smaller. In addition, providing the recess 11b allows the occupant to be sufficiently decelerated by the seat belt before the occupant's head plunges into the airbag 11.

Additional embodiments of the airbag 11 will now be described. In the following embodiments and examples, various methods are employed so that the shape of the recess is maintained even when the right and left sides of the airbag are compressed as shown FIG. 2(a).

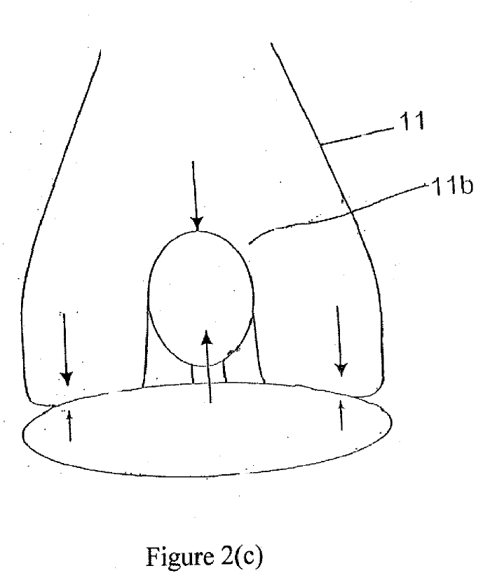

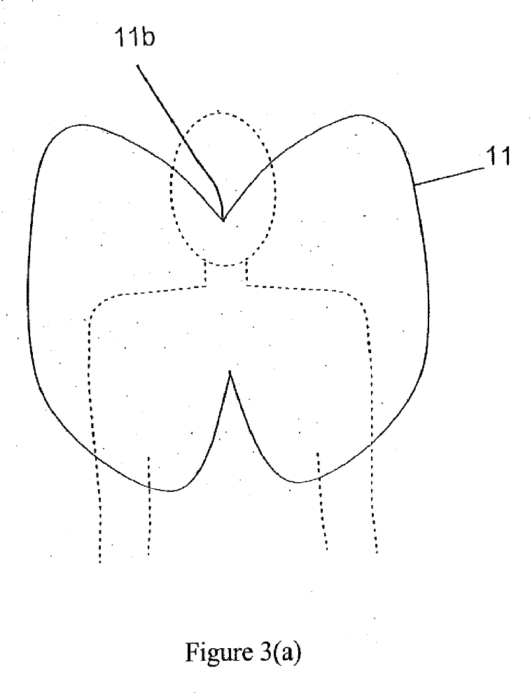

FIGS. 3(a) and 3(b) show another embodiment. FIG. 3(a) shows an airbag 11 when deployed. FIG. 3(b) shows a left half side airbag LAB. The airbag 11 of FIG. 3(a) is formed by connecting two airbags—a right side airbag and a left side airbag—together to form one airbag 11. As shown in FIG. 3(b), an opening I for inserting an inflator is provided at the base of the airbag. As in FIGS. 1(a) and 1(b), the front side of the airbag 11 comprises a contact surface 11a, which makes contact with an occupant when the airbag deploys. A recess 11b is provided in the center area of the contact surface.

As shown in FIG. 3(b), the left half side airbag LAB and the right half side airbag have a communication portion C, which communicates with one end of the left half side airbag LAB and one end of the right half side airbag. The communication portion C is disposed at the base side of the airbag 11. Therefore, the left half side airbag LAB and the right half side airbag inflate respectively in a direction away from the communication portion C.

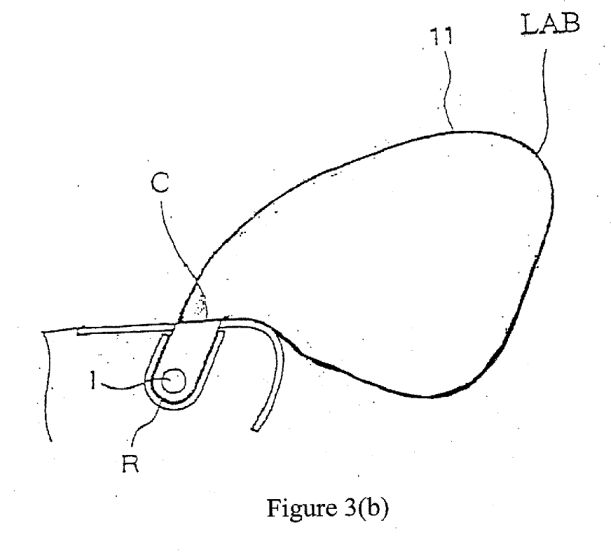

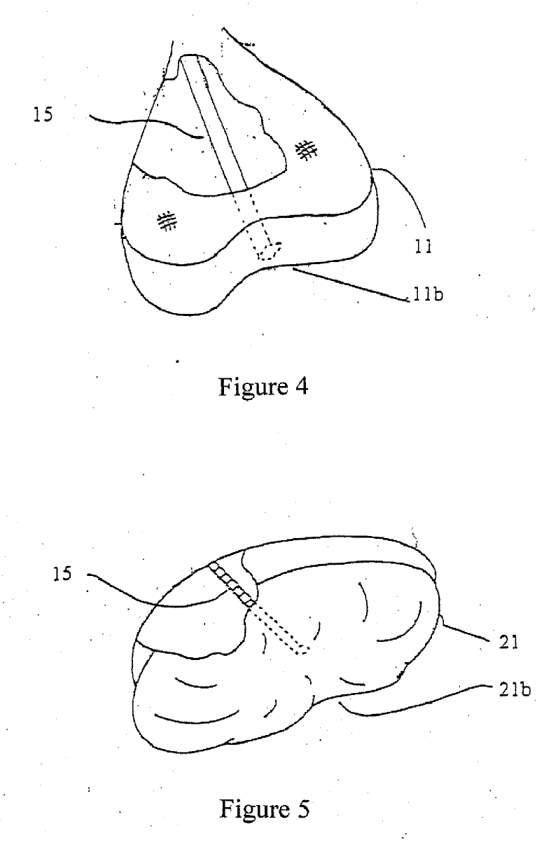

FIG. 4 shows another embodiment in which a tether belt is attached to the recess 11b of an airbag 11. The airbag 11 shown in FIG. 4 is similar to the airbag shown in FIG. 3(a). The one end of the tether belt 15 is sewn to the inner surface of the airbag 11 adjacent to the bottom of the recess 11b. The other end of the tether belt 13 is sewn to the inner surface of the airbag 11 adjacent to the end opening of the airbag 11. The tether belt 15 is made of a material with an expansion rate lower than that of the airbag 11. The tether belt 15 may, for example, be a string or a band-shaped cloth.

By adding a tether belt 15, the shape of the recess 11b can be maintained when the airbag 11 is inflated.

FIG. 5 shows another embodiment in which a tether belt 15 is attached to a conventional airbag 21. FIG. 5 shows a conventional airbag 21 without a recess 11b. One end of the tether belt 15 is sewn to the inner surface of the airbag 21 adjacent to the central area of the airbag facing the occupant, The other end of the tether belt 15 is sewn to the airbag 21 adjacent to the end opening of the airbag. When the airbag 21 inflates, the central area of the airbag facing the occupant is pulled by the tether belt 15 to form a recess 21b. Since this embodiment can be applied to a conventional airbag, construction of the airbag can be made easy.

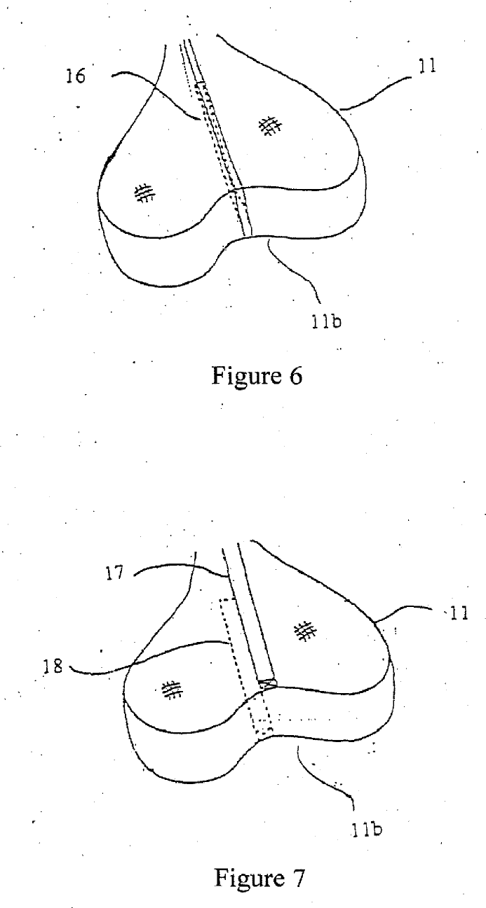

FIG. 6 shows another embodiment in which tether belts 16 are attached to the outside surface of the airbag surrounding the recess 11b of the airbag 11. The airbag 11 shown in FIG. 6 is similar to the airbag shown in FIG. 3(a). Tether belts 15 are wrapped around the recess 11b of the airbag. Ends of the tether belts are sewn to the airbag adjacent to the end opening of the airbag.

FIG. 7 shows another embodiment in which tether belts 17, 18 are attached to the airbag 11 on the upper and lower surface of the airbag adjacent to the recess 11b.

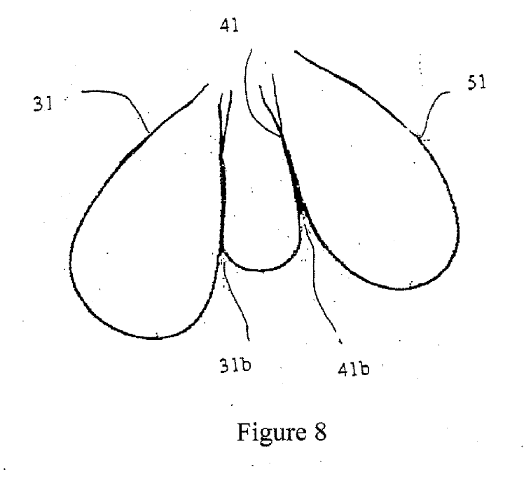

FIG. 8 shows another embodiment in which three airbags 31, 41, 51 are employed. An inflator (not shown) is provided for each of the airbags. As shown in FIG. 8, recesses 31b, 41b are formed on a front surface formed by the airbags 31, 41, 51.

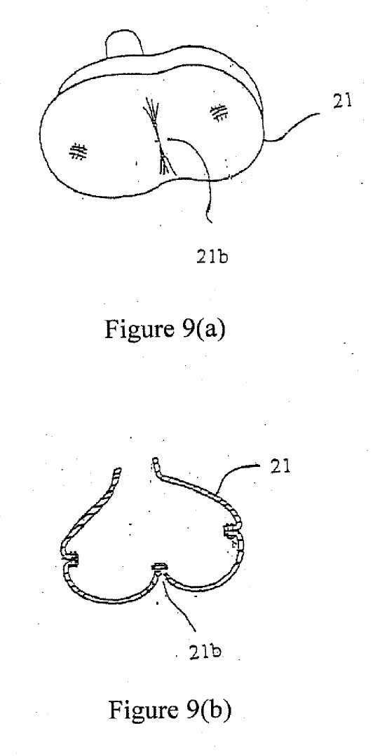

FIG. 9 shows another embodiment of an airbag device. FIG. 9(a) is a perspective view of this embodiment. FIG. 9(b) is a cross sectional view of the embodiment of FIG. 9(a). In this embodiment, a part of a conventional airbag 21 is sewn together and also the periphery of the conventional airbag is sewn together. The sewn pans form a recess 21b in the front of the airbag 21.

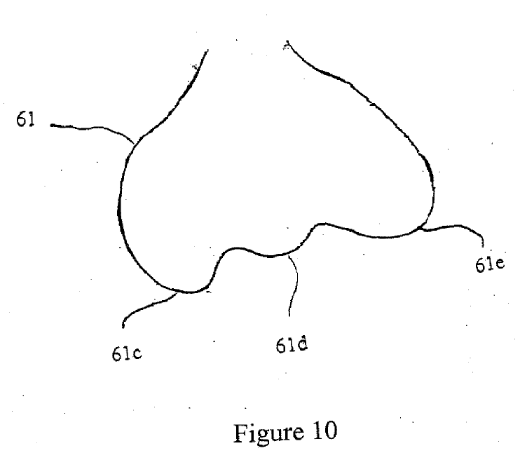

FIG. 10 shows another embodiment in which the airbag 61 has three projecting portions 61c, 61d, 61e. To construct this airbag, any of the methods used to produce the above embodiments can be used. Thus, the number of projecting portions of the airbag according to the invention can be increased to three

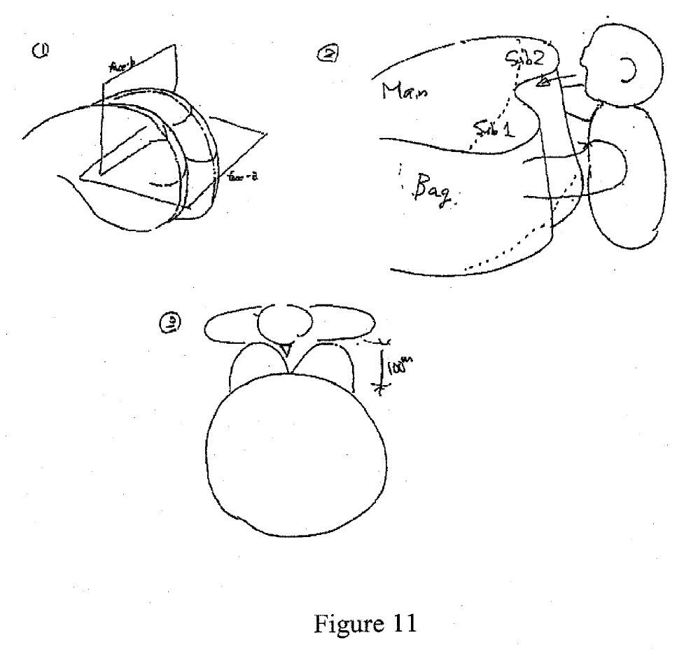

FIG. 11 shows another embodiment of an airbag device. In this embodiment, the airbag has a left and a right projection on the front of an airbag that faces an occupant. A horizontal distance from the distal ends of the left and right projections to a deepest part of the space between the left and fight projections is about 25 mm to about 1000 mm. Preferably, the horizontal distance from the distal ends to a deepest part is about 50 mm to about 750 mm. More preferably, the horizontal distance from the distal ends to a deepest part is about 75 mm to about 600 mm. More preferably, the horizontal distance from the distal ends to a deepest part is about 100 mm to about 480 mm. In one embodiment the airbag has a recess for an occupant's head on the occupant's side of the airbag. In one embodiment the airbag has a flat face at the portion of the airbag that contacts the vehicle body or parts and a recess or indentation at the portion that does not contact the vehicle body. For example, the indentation may be on the occupant's side of the airbag.

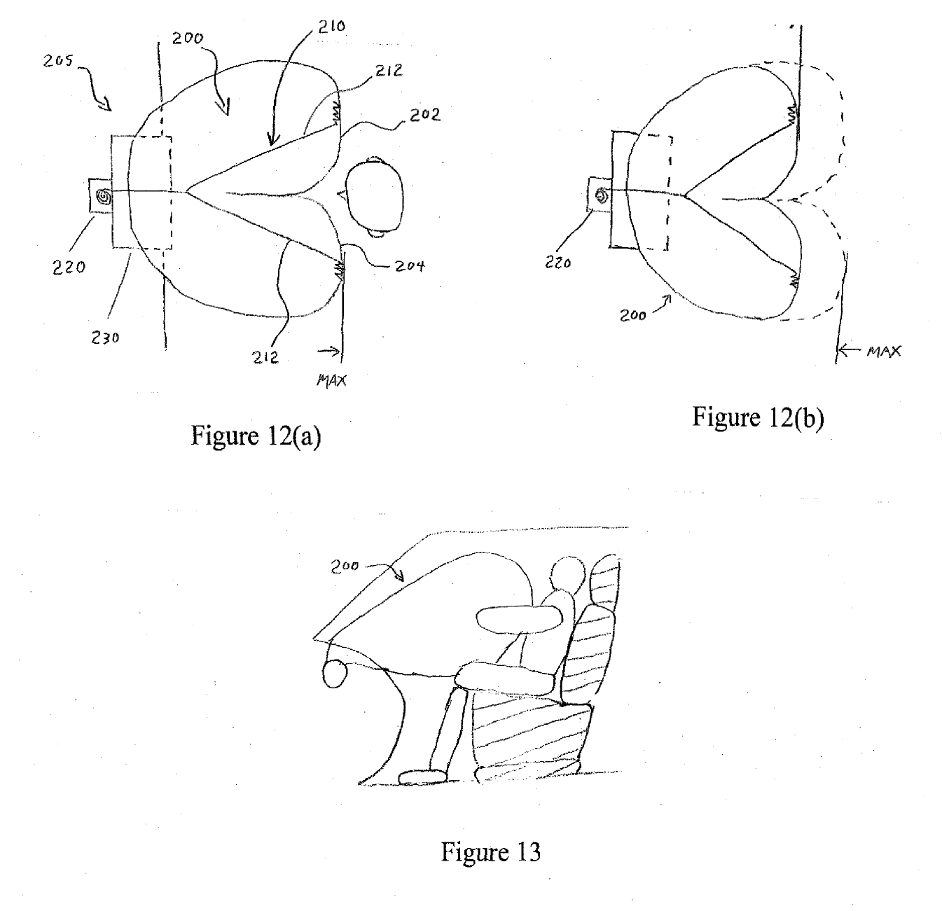

FIG. 12(a) shows a top view of an airbag device 205 according to an embodiment that is used to control the shape of an airbag 200. In the example shown in FIG. 12(a), a tether 210 is used to restrain the airbag 200 and control the shape of an airbag 200 to a maximum size when an airbag 200 is deployed, the airbag 200 is restrained by the tether 210 so that the shape and size of the airbag are controlled, For example, the deployment of the airbag 200 may be controlled in response to a crash situation that has been detected.

The tether 210 shown in the example of FIG. 12(a) is a single member that is split or divided to attach at the ends of different airbag members or chambers 202, 204. For example, the tether 210 can be split or divided into a separate tether 212 for each member or chamber 202, 204 or the tether 210 may be split into a plurality of strands 212 for each member or chamber 202, 204. The tether can also include separate, multiple tethers. The tether 210 can be attached to a winder, winch, or other tether control device 220 to control the deployed length of the tether 210, and therefore the deployed shape and size of an airbag 200. The tether winding device 220 can be mounted to an airbag retainer 230 that houses the airbag 200 in its folded and/or rolled state. The airbag device 205 can be used to control, more than two different airbag sizes in deployment. The tether may comprise fabric, cord, wire or the like. For example, airbag fabric may be used for the tether according to one embodiment.

FIG. 12(b) shows a top view of an airbag device 205 that has been deployed to a controlled size. In the example shown in FIG. 12(b), the airbag size has been controlled to a minimum size. A minimum size is illustrated with solid lines while a maximum size is illustrated with broken lines. FIG. 13 shows a side view of the deployed airbag device 205.

According to an embodiment, the airbag device 205 is used to control the area of vent holes. For example, the airbag device 205 can be used to control the area of vent holes by controlling the size and shape of the airbag 200. In a further embodiment, the airbag device includes a size controlling device, such as the device described above, and a vent hole area controlling device.

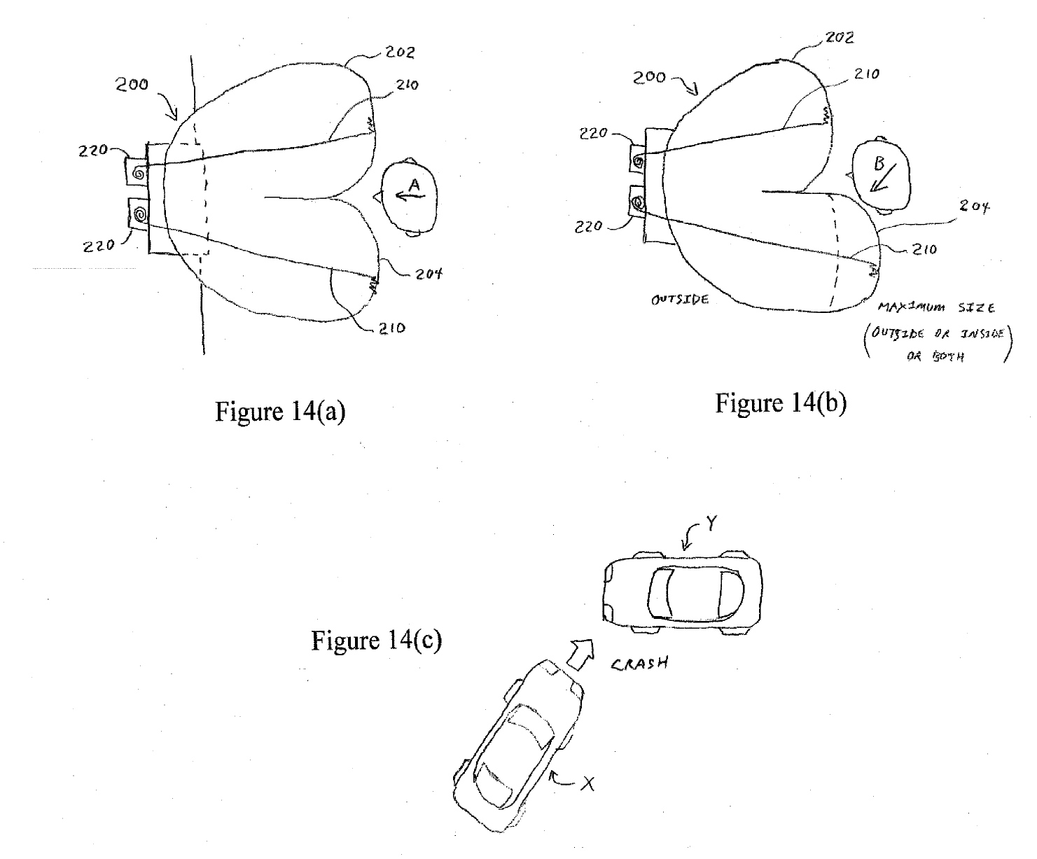

FIG. 14(a) shows a top view of an embodiment in which two tethers 210 are used to control the size and shape of an airbag 200. In the example shown in FIG. 14(a), two tethers 210 and two corresponding winding devices 220 are used. However, a single winding device 220 may be used to wind two or more tethers 210. A plurality of tethers 210 may be used or a tether 210 may be split at its end to connect to an airbag member or chamber 202, 204. In such configurations, the airbag members or chambers 202, 204 may be controlled independently so that they deploy to different sizes, Arrow A, as shown in the head of an occupant, indicates a direction that the occupant is traveling in.

FIG. 14(b) shows a top view of an airbag 200 that has been deployed to a controlled size. In the example shown in FIG. 14(b) the inside airbag chamber 202 (the member at the top of the figure closer to the centerline of the vehicle) has been controlled to a size that is relatively smaller than the outside airbag chamber 204 (the chamber at the bottom of the figure closer to the side of the vehicle). In the example shown in FIG. 14(b) the outside chamber 204 has been deployed to a maximum size. Such a configuration may be selected in response to a detected crash situation, such as the example shown in FIG. 14(c) where a vehicle X will strike an occupant's vehicle Y from an angle. In such a situation, the occupant will travel in the direction shown by Arrow B in FIG. 14(b). The airbag 200 may deploy, for example, into a configuration corresponding to the size and shape shown in FIG. 14(b) in order reduce or prevent injury to an occupant as a result of the occupant's vehicle being involved in the crash situation shown in FIG. 14(c).

In an embodiment, the size and shape of an airbag may be controlled in response to signals from detection devices. For example, sensors such as, for example, seat weight sensors (SWS), cameras, proximity devices, and other crash detection devices known in the art may be used. Signals received from the sensors can be used to control the size and shape of the airbag in relation to the conditions detected by the sensors. For example, a signal received from a seat weight sensor can be used to control the size of an inner airbag chamber and/or or outside airbag chamber to accommodate the size and/or position of a vehicle occupant. In another example, signals received from cameras, proximity devices, and/or other crash detection devices can be used to determine a crash condition, as well as a size and shape of the airbag for accommodation of a vehicle occupant.

In a further embodiment, the airbag device can include a controller that receives signals from sensors, such as, for example, seat weight sensors (SWS), cameras, proximity devices, and other crash detection devices known in the art, and controls the winding devices 220 in response to the signals from the sensors.

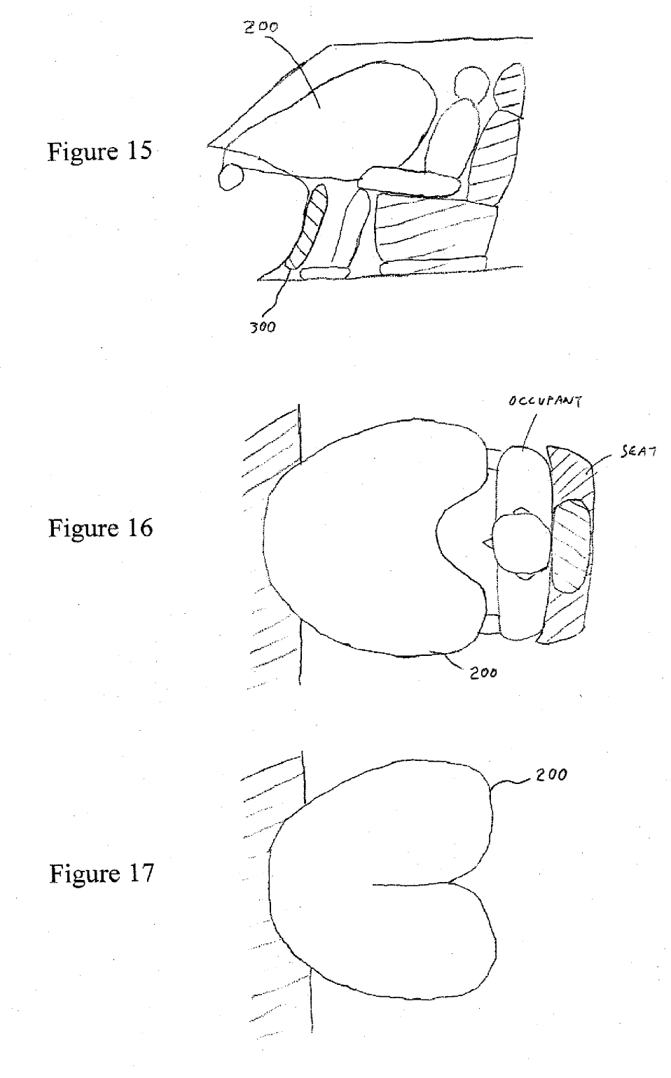

FIG. 15 shows an embodiment in which an airbag device 205 according to an embodiment described above is used in combination with a knee bolster and/or a knee bag 300 to restrain an occupant.

In an embodiment, an airbag device 205 according to an embodiment described above is used in combination with a seat belt retractor (erg., motorized seat belt retractor MSR) to restrain an occupant. In a further embodiment, an airbag device 205 according to an embodiment described above is used in combination with a knee bolster, a knee bag, and MRS to restrain an occupant.

According to an embodiment, an airbag device is adapted to adjust more than two levels of size for each airbag in the direction of an occupant during deployment.

FIGS. 16 and 17 show top views of examples of airbag sizes and shapes that are capable of being produced with the present invention.

The present invention in its broader aspects is not limited to the specific airbag devices according to the embodiments shown and described herein with reference to FIGS. 1 through 17.

As described above, by modifying the configuration of the airbag, an occupant can be protected in a more efficient manner.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments.

What is claimed is:

1. An airbag device, comprising:
an airbag including first and second chambers, a recess formed in an exterior surface of the airbag between the first and second chambers;
a tether connected to at least one of the first and second airbag chambers; and
a winding device connected to the tether, wherein the winding device is arranged to control the size and shape of the airbag when the airbag is in a deployed state.

2. The airbag device of claim 1, wherein the tether includes first and second members, wherein each member is connected to at least one of the first and second chambers.

3. The airbag device of claim 2, wherein the winding device includes first and second winding devices.

4. The airbag device of claim 3, wherein the first member is connected to the airbag in the first chamber and wherein the second member is connected to the first winding device, and wherein the size and shape of the first chamber is controlled by the first winding device; and
wherein the second member is connected to the airbag in the second chamber and wherein the second member is connected to the second winding device, wherein the size and shape of the second airbag chamber is controlled by the second winding device.

5. The airbag device of claim 1, wherein the winding device is configured to control the size and shape of the airbag to more than two different airbag sizes when the airbag is in a deployed state.

6. The airbag device of claim 1, wherein the winding device is configured to control the size and shape of the airbag by controlling the size and shape of the first and second chambers.

7. The airbag device of claim 6, wherein the winding device is configured to control the size and shape of the first and second chambers independently.

8. The airbag device of claim 1, wherein the winding device is configured to control the area of at least one vent hole.

9. The airbag device of claim 8, wherein the winding device is configured to control size and shape of the airbag to more than two different airbag sizes when the airbag is in a deployed state.

10. The airbag device of claim 1, wherein the winding device is configured to receive an input signal related to an output of a sensor and to control the size and shape of the airbag in response to the sensor output.

11. A vehicle safety system comprising:
an airbag comprising two chambers separated by a recess in the surface of the airbag; wherein the recess is positioned so that when the airbag deploys the recess faces an occupant of the vehicle; wherein the airbag includes an internal tether, wherein the tether includes first and second portions; wherein each of the first and second portions is connected to one of the two chambers;
a tether control device for controlling the length of each the tether portions so that the deployment of the two chambers can be separately controlled;
a sensor for sensing a vehicle or occupant characteristic.

12. The system of claim 11, wherein the sensor comprises a seat weight sensor.

13. The system of claim 11, wherein the sensor comprises a camera.

14. The system of claim 11, further comprising a controller, wherein the controller receives a signal from the sensor and sends a signal to the tether control device to thereby control the length of the tether portions and the corresponding position of the deployed airbag.

15. The system of claim 11, wherein the tether control device is configured to allow the airbag to deploy asymmetrically.

16. The system of claim 11 , wherein the tether control device comprises a winder for the tether.

17. The system of claim 16, wherein the winder is connected to an airbag retainer.

18. The system of claim 14, further comprising a knee bolster, wherein the deployment of the knee bolster is controlled by the controller.

19. The system of claim 14, further comprising a motorized seat belt retractor controlled by the controller.

20. A vehicle safety system comprising:
a two chambered passenger side airbag including a pair of internal tethers, wherein each tether extends from a position adjacent an inflation gas input opening at one end to one of the chambers at another end;
wherein the dual chambers are separated by a recess in the surface of the airbag; wherein the recess is positioned so tat when the airbag deploys the recess faces an occupant of the vehicle;
a tether control device for controlling the length of each the tethers so that the shape of the deployed airbag is asymmetrical.
